(19) United States
(12) Patent Application Publication
(10) Pub. No.: US 2016/0366854 A1
(43) Pub. Date: Dec. 22, 2016

(54) SYSTEMS AND METHODS FOR MONITORING A SUBJECT IN A PREMISES

(71) Applicant: Radio Systems Corporation, Knoxville, TN (US)

(72) Inventors: Christopher Mainini, Knoxville, TN (US); Richard Alan Seltzer, Knoxville, TN (US); Phil Peery, Knoxville, TN (US); Edward Hoyt, Knoxville, TN (US)

(21) Appl. No.: 14/880,935

(22) Filed: Oct. 12, 2015

Related U.S. Application Data
(63) Continuation-in-part of application No. 14/741,159, filed on Jun. 16, 2015.

(51) Int. Cl. A01K 11/00; H04W 4/02; A01K 29/00; H04W 4/00

(52) U.S. Cl. CPC A01K 11/008; H04W 4/008; H04W 4/023; A01K 29/005

(57) ABSTRACT

A system is described that includes communications modules, a wearable device, and an application running on a processor of a computing platform. The system includes placing each communications module at a location in a premises, wherein each communications module periodically transmits a unique number, wherein the application detects and stores each unique number. The system includes the application organizing linking information by linking each unique number with a function and transmitting the linking information to the wearable device. The wearable device may detect a transmission of a communications module and use information of the transmission to identify the communications module's unique number. The wearable device may use the linking information to identify the corresponding function and perform the function when at least one criterion is met.

### CROSS REFERENCE TO RELATED APPLICATIONS

This application is a continuation in part application of U.S. patent application Ser. No. 14/741,159, filed Jun. 16, 2015.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

As a result of work, school, and other obligations, most pet owners cannot be with their pet at every moment of every day. However, some pets, due to various conditions, behaviors, and circumstances, require some form of monitoring throughout each day or at least at particular times. This is particularly true if an owner allows a pet to freely roam a home premises in the owner's absence. There is a need to provide systems, methods and devices that track the location of a pet in a premises and that monitor and guide its behavior in such premises.

### BRIEF DESCRIPTION OF THE DRAWINGS

So that the manner in which the present application can be better understood, certain illustrations and figures are appended hereto. It is to be noted, however, that the drawings illustrate only selected embodiments and elements of the systems and methods described herein and are therefore not to be considered limiting in scope for the systems and methods as described herein may admit to other equally effective embodiments and applications.

FIG. 1 shows beacons deployed at various locations in a home premises, under an embodiment.

FIG. 2 shows the components of a monitoring system, under an embodiment.

FIG. 3 shows an application interface providing discovery options, under an embodiment.

FIG. 4 shows an application interface providing configuration options, under an embodiment.

FIG. 5 shows a representative database entry of a database stored in a collar device, under an embodiment.

FIG. 6 shows an application interface providing configuration options, under an embodiment.

FIG. 7A shows a beacon defined interaction between beacon and collar device, under an embodiment.

FIG. 7B shows a collar defined interaction between beacon and collar device, under an embodiment.

FIG. 8A shows a one way communication between smartphone and collar device, under an embodiment.

FIG. 8B shows two way communications between smartphone and collar device, under an embodiment.

FIG. 9 shows an application interface providing user a selection among multiple beacons, under an embodiment.

FIG. 10 shows a remote training application interface, under an embodiment.

FIG. 11 shows a method of monitoring a subject in a premises, under an embodiment.

FIG. 12 shows components of a monitoring system, under an embodiment.

FIG. 13 shows a system for monitoring a subject in a premises, under an embodiment.

FIG. 14 shows a system for monitoring a subject in a premises, under an embodiment.

### DETAILED DESCRIPTION

The demographics of pet ownership have been changing. The size of pet dogs has been getting smaller, they stay inside the home longer per day; if not all day. Both young and older individuals are gravitating towards smaller dwellings. Metropolitan living is becoming more popular. As a result, apartments and condominiums in cities and municipalities are easing their restrictions related to dog occupancy in these smaller living spaces. Therefore, a market is being defined based on the needs for these (but not limited) to metropolitan pet owners.

Specifically looking at the needs of this demographic group, some of the more “rural” pet solutions do not apply. Coupled with the new technology platforms available and the prevalence of smart phones and internee availability, new solutions emerge. And in response to the general cry of consumers for products with more features and benefits with less complexity and “hassle”, the systems and methods described herein answer that call.

Consider the reduced size of the pet's home in the metropolitan environment. The pet owners would like control of the pet's allowable whereabouts (stay out of the kitchen, ok in living room etc.), and knowledge of its routine activities (when did she sleep and where?, did she bark?, did she eat, drink and when? etc.). This disclosure provides for the simple set up of a monitoring/tracking/detection/training/avoidance system, easy configuration of system components, and optionally worldwide, real-time access to the information.

The systems and methods described herein include distributing pet beacons in a house at strategic locations to provide monitoring/tracking/detecting/training/avoidance functionality for pets. These devices are designed to periodically transmit a unique identification code along with functional parameters. Currently, such devices transmit signals for a distance of up to 70 meters. They are designed to be either battery or line powered, are small and easily located anywhere in the home. The individual beacons do not have an assigned function under one embodiment. This allows for simple activation and placement. Under one embodiment, beacons send unique identification and health status only (i.e. battery life). Under alternative embodiments, beacons may also transmit minimum and maximum signal strength values and other functional parameters.

The systems and methods described herein include providing pet collar devices. Under an embodiment a pet wears a collar that is designed to receive beacon transmissions, and act upon and/or store the data transmissions. Pet collar devices may also transmit beacon configuration data and summarized collected data from all monitored beacons to one or more smartphone receivers. The collar is also capable of providing positive and negative reinforcement as necessary utilizing a number of different stimulation techniques.

Under one embodiment, beacons comprise Bluetooth® Low Energy beacons. Under alternative embodiments, beacons comprise Bluetooth Low Energy peripherals capable of RF connection. Further, collars may comprise Bluetooth low energy enabled devices that function in a manner analogous to beacons. Bluetooth low energy (BLE) is itself a wireless technology standard for personal area networks. BLE is targeted for very low power devices, i.e. devices that can run on a coin cell battery for months or years. Under an embodiment, Bluetooth enabled beacons/devices may comprise Bluetooth integrated circuit implementations. Updates to embedded code of a Bluetooth enabled device may be accomplished through firmware over the air upgrades. Mobile device operating systems may natively support the Bluetooth low energy wireless communications protocol. Such operating systems include iOS, Android, Windows Phone and BlackBerry, as well as OS X, Linux, and Windows 8.

A smartphone application is described herein that is used to set up, and configure the in-home detection/monitoring system and configure its components. The smartphone application may also be used to monitor and control beacons and/or collar devices and upload monitored data. As one example, the smart phone application, when in range of either a beacon or a collar device may receive data from such devices, collect the data and/or store the data. The smart phone application may also cause action by a device such as the collar or any beacon, manually or automatically. As further described below, the application may wirelessly signal the collar device to apply a corrective action, i.e. apply a stimulus to the corresponding pet. When configuring the system, the application may provide a simple user interface for configuring the system, its components and their functionality.

It should be noted that beacons, the pet collar device(s) and mobile devices may both transmit and receive data. Accordingly, each such component/device may serve a dual function of transmitting and receiving/collecting data as further described below. In the examples provided below, beacons and pet collar devices are Bluetooth enabled but embodiments are not so limited. Further in the examples provided below an operating system of a mobile device (running a smartphone application of the system described herein) natively supports Bluetooth communications. Such operating system also natively supports any other communications protocols as they become available.

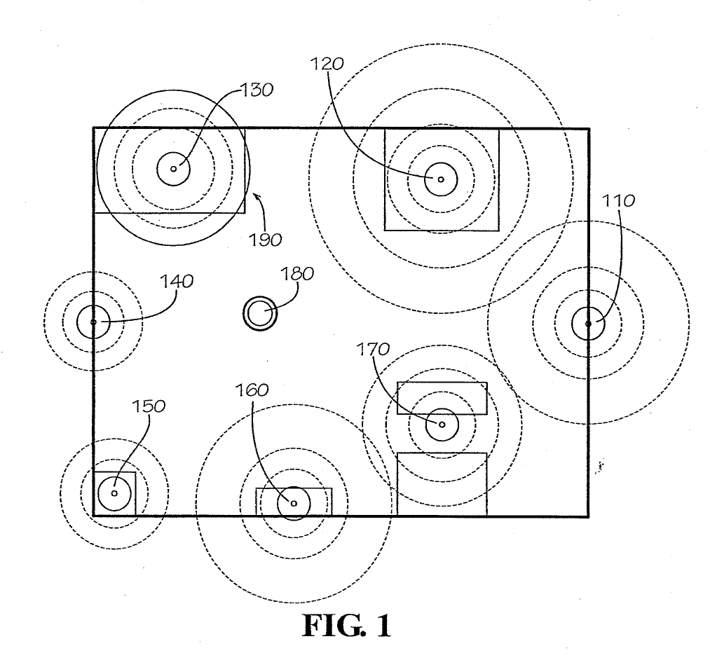

Assume that a user implements the tracking/monitoring system within a one bedroom apartment premises/home. Under such embodiment, FIG. 1 shows a home premises featuring a plurality of beacons 110-170 distributed by owner/user throughout the premises. FIG. 1 shows a beacon 120 placed in a bathroom of the home. FIG. 1 shows a beacon 130 placed in a bedroom of the home. FIG. 1 shows a beacon 110 placed at a front door of the home. FIG. 1 shows a beacon 140 placed at a living room window of the home. A beacon 170 may also be placed in a kitchen of the home. It is of course possible to place a beacon just about anywhere in, or around, the premises including in proximity to the pet's bed (beacon 160), food/water bowl (beacon 150) or other locations that may require monitoring, e.g. pet doors, furniture, outlets, etc. The dotted circles indicate the RF energy emitted from each beacon. A solid circle 190 indicates a range or threshold distance from each beacon configured be an “action” or “threshold” distance as further described below.

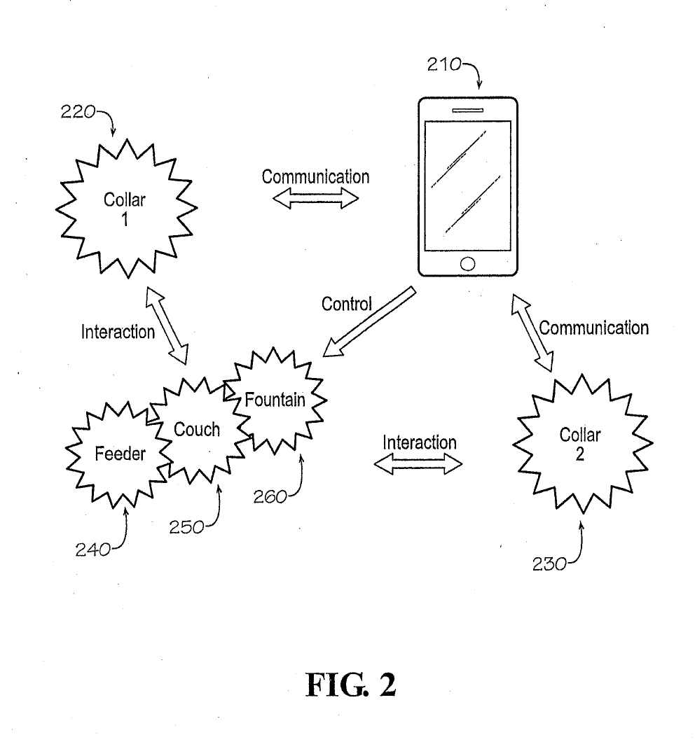

FIG. 2 shows the components of a monitoring/tracking/detection system under an embodiment. FIG. 2 shows mobile device 210 running a smartphone application. The smartphone application is communicatively coupled to collar devices 220, 230. The smartphone application may transmit data to and control certain functions of the collar devices 220, 230 as further described below. The smartphone application may also receive data from collar devices as further described below. FIG. 2 shows collar devices 220, 230 communicatively coupled to beacons 240, 250, 260. The collar devices receive data periodically transmitted by beacons 240, 250, 260 and otherwise communicate with beacons 240, 250, 260 as further described below. The smartphone application 210 may assign certain functionality directly to beacons 240, 250, 260 and otherwise communicates with beacons as further described below.

As seen in FIG. 1, the beacons are indicated by dots located in select areas in a one-bedroom apartment, for example. A Bluetooth enabled beacon may periodically transmit data including a unique identification number. A Bluetooth enabled device, e.g. the collar device described herein, may receive the periodically transmitted data, extract the identification number and estimate the transmission's signal strength (i.e. received signal strength indication or “RSSI”). The collar device may then use the signal strength to estimate a distance from collar device to the transmitting beacon. The collar may be further assisted with its ranging calculation by utilizing calibration data contained within the beacon message. Further, the collar device itself periodically transmits data including a unique identification number. Under one embodiment, the collar device cycles between “transmission” and “listening” modes. As one example the collar device may periodically transmit data during a “transmission” period and then simply receive incoming signals from in range beacons/devices during a “listening” period. The collar may shift between “transmission” and “listening” periods in five second intervals. Under one embodiment, beacons similarly shift between transmission and listening modes.

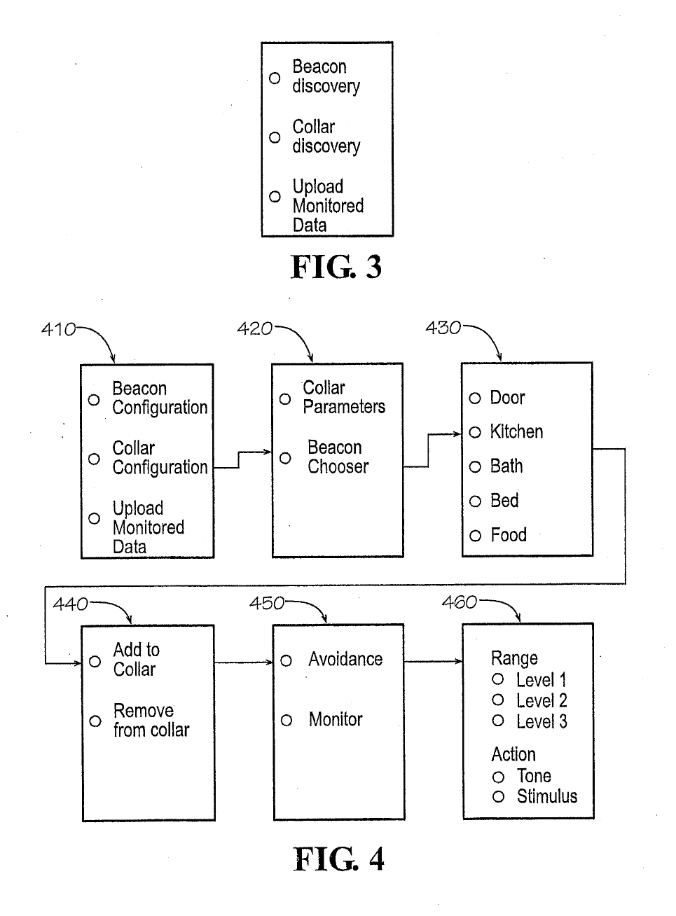

Under one embodiment, the smartphone application may provide an “easy to use” configuration interface. A pet owner may initiate the application on a smartphone and walk through a set up procedure using the configuration interface. For example, such interface of the application may provide click through buttons for “beacon” and “collar” discovery modes as seen in FIG. 3. The user may under this embodiment select “beacon” discovery mode. The interface may then prompt the user to bring the smartphone device in proximity to a transmitting beacon, i.e. within transmission range of a beacon. In beacon discovery mode, the application may use one or more mobile device operating system APIs to detect incoming Bluetooth transmissions. The application and mobile device detect the periodically transmitted beacon signal and identify/store its unique identification number. The mobile device may use strength of incoming signal to estimate a distance from the beacon. Under one embodiment, the application may only enable availability of discovery mode in close proximity to the transmitting beacon. The user may repeat this process for each and every beacon that the user wishes to deploy in the premises. In this manner, the application learns the identification number of each beacon deployed in the premises.

Continuing with this configuration example, a user runs the same application on the user's smart phone to configure the collar device for operation. As indicated above, an interface of the application may provide click through buttons for “beacon” and “collar” discovery modes as seen in FIG. 3. The user may under this embodiment select the “collar” discovery mode. The user brings the smartphone device in proximity to the pet collar device, i.e. within transmission range of the collar. In collar configuration mode, the application may use one or more mobile device operating system APIs to detect incoming Bluetooth transmissions originating from the collar device. The application and mobile device detect the periodically transmitted signals from the collar device and identify its unique identification number. The mobile device may use strength of incoming signal to estimate a distance from the collar device. Under one embodiment, the application may only enable availability of collar device discovery mode in close proximity to the collar device. The user may repeat this process for each and every collar device that the user wishes to deploy in the premises. In this manner, the application learns the identification number of each collar device deployed in the premises.

In this manner, the application may learn the unique identification number of all premises beacons and the pet collar devices. It should be noted that FIG. 3 provides a separate interface for discovery of beacons and collar devices. However, the discovery mode interface may be integrated into the workflow of beacon/collar configuration interfaces shown in FIGS. 4 and 6 and further described below. Note also that FIG. 3 provides Upload Monitor Data allowing the option to trigger upload of data collected by collar device to the smartphone.

A user may use the smartphone application to configure the collar (or collars) for operation, i.e. to configure “collar defined” functions or enable recognition of specific “tag defined” beacons. The collar itself performs a set of “active” and/or “passive” functions. Proximity to a beacon triggers one or more such functions as defined by the user with respect to the particular beacon. In other word, for each deployed beacon the user defines a collar implemented function triggered by the collar's entry into a defined proximity of a particular beacon.

FIG. 4 shows an interface allowing a user to configure collar defined functions with respect to specific beacons. This system of this embodiment comprises a single collar and multiple beacons. Screen 410 shows a Beacon Configuration option (described below with respect to FIG. 6), a Collar Configuration option, and an Upload Monitor Data option. (The Upload Monitor Data Option of screen 410 provides the option to trigger upload of data collected by collar device to the smartphone). A user selects under one embodiment the Collar Configuration option and is presented with screen 420. At this screen 420 a user may select Collar Parameters or Beacon Chooser. The Collar Parameters option introduces an interface (not shown) for configuring functional parameters of the collar such as correction level. A user selects under an embodiment Beacon Chooser and proceeds to screen 430 which lists the beacons available within the system (e.g. door, kitchen, bath, bed, food). The user selects the kitchen beacon and is provided a choice at screen 440 between Add to Collar and Remove from Collar. The user may select Add to Collar to associate the kitchen beacon with the collar device. (The user may also select Remove from Collar to dissociate from the collar device a previously assigned beacon). After associating the kitchen beacon with the collar device, the user sees screen 450 featuring Avoidance and Monitor options. A user may assign the kitchen beacon an Avoidance function or a Monitor function. After selecting Avoidance, the user manipulates interface selections (at screen 460) to assign the collar a stimulus function when the collar is within a selected range (Level 1) of the beacon. Specifically the user selects a negative stimulus (applied by the collar) as an avoidance function and designates a corresponding range. The application interface may provide various stimulus functions (tone, stimulus, scent, etc.) and one or more ranges. Range Level 1 for example indicates close proximity to a beacon. Range Level 2 and Range Level 3 represent enlarged threshold distances. After selecting range and function, the user may be presented with another screen (not shown) allowing user to designate permitted access times, e.g. times during which the collar does not apply the designated function when the collar device in within the designated range. Embodiments are not limited to the functions and ranges described in FIG. 4. In this example, the user simply directs the collar to perform an avoidance function when the collar is within a near range threshold distance of the beacon. Once the configuration selections are complete for a collar/beacon combination, the application may prompt the user to bring the application in proximity to the collar device. The application may then transmit such configuration data to the pet collar device which uses the data to build/maintain a database which associates actions/functions with beacons (and corresponding unique identification numbers and permitted times). In this manner a user may assign functions to the collar with respect to each beacon within the system.

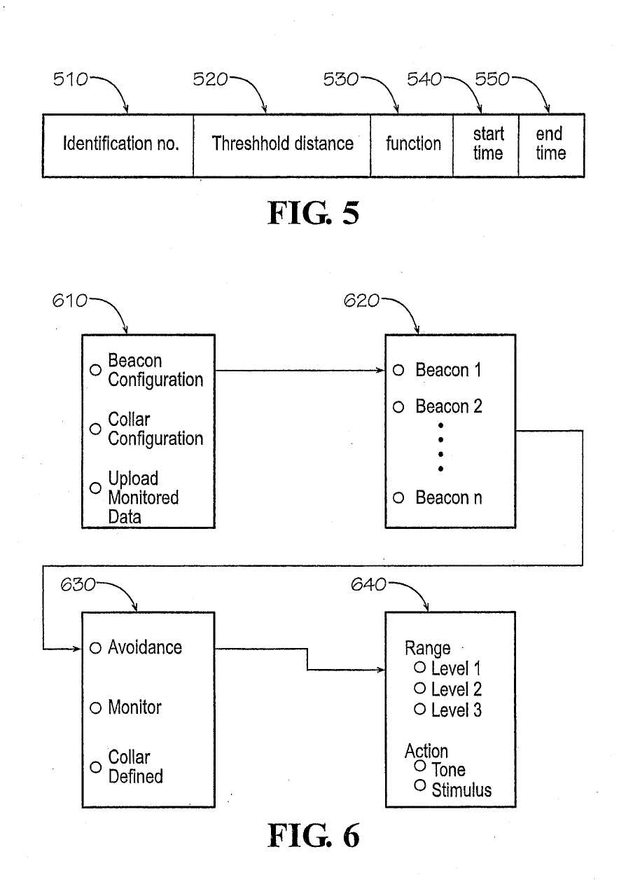

FIG. 5 shows a representative entry in a database which associates beacon identification number 510 with an avoidance function 530 and threshold distance 520. The representative database entry also includes start time 540/end time 550 of the configured function. Such database may associate values using a relational database scheme.

Continuing with this example, an operational pet collar device approaches the particular beacon and crosses over the configured threshold distance. During this event, the particular beacon simply transmits is unique identification number. The collar device receives the signal, identifies the unique identification number, and uses signal strength of the transmission to estimate a distance to the beacon. The collar device then uses the identification number to perform a database lookup to determine the assigned collar function with respect to the beacon (e.g., a negative stimulus) and conditions for its performance (e.g. location of the collar device within a certain threshold distance and permitted time of performance). In this example, the collar determines that the function is delivery of stimulus and also resolves that the estimated distance from collar to beacon is less than the selected threshold distance (via comparison of estimated distance with designated threshold distance). Therefore, the collar device delivers the avoidance stimulus to the pet wearing the collar device. It should be noted that threshold distance may comprise distance from a location or a range of such distances (including an upper and lower boundary).

In the example above, the assigned function comprises a user/collar defined function. In other words, a user may assign functions to collar/beacon combinations. For example, a user may wish to prevent a pet from jumping on the user's couch. Therefore, the user may assign a beacon located near the couch an avoidance function, i.e. assign an avoidance function to a collar with respect to such beacon. However, a user may simply wish to know how often a pet visits a water bowl in daytime hours while the user is away from the premises, i.e. the user may simply wish to track the location of a pet. Accordingly, a user may assign a beacon located near the water bowl a tracking function, i.e. assign a tracking function to a collar with respect to such beacon. The user then assigns the collar device the tracking function via the application in the same way the avoidance function is assigned (as described above). When the pet collar device is within a threshold distance of the beacon (and once the collar device processes conditions for performance of the assigned function based on beacon/function/distance/time parameters), the pet collar device simply logs location data, e.g. the occurrence of a threshold crossing, the time of a threshold crossing, duration of pet's proximity to a beacon, etc.). The tracking beacon may under an embodiment also administer a positive reinforcement such as a positive tone if so configured by the user.

The flexibility of the system is evident in view of a second pet collar device. Within the same monitored premises, the configuration process described above may be used to assign functions to a second collar device with respect to the same set of beacons. This set of functions may be entirely different than those assigned to the first collar. This is possible due to the fact that beacons merely transmit identification numbers while the collar devices detect/extract the identification numbers and then resolve/perform a user defined function based on configuration data stored in a collar specific database.

In contrast to “user defined” functions, a user may also dedicate a specific beacon to a particular task. For example, a user may use the application interface during setup to assign an avoidance function to a beacon directly. An example of directly configuring a beacon defined function using a smartphone application is provided below. A user initiates the smartphone application which under one embodiment provides an interface for assignment of functions directly to beacons. FIG. 6 shows a screen 610 featuring Beacon and Collar Configuration options as well as a Monitor Data option. For example, a user may select the Beacon Configuration option shown in FIG. 6. The interface may then present at the next screen 620 all discovered beacons, i.e. up to “n” number beacons discovered via the process described above and as seen in FIG. 6. (It should be understood that Beacons 1-n may be replaced by the names of the monitored locations, e.g. kitchen, door, window, etc.). A user then selects a particular beacon (e.g. beacon 2) and then views configuration options at screen 630 for the pet collar with respect to the selected beacon. Screen 630 shows Avoidance and Monitor options which represent options to assign an Avoidance or Monitor function to the beacon. (The Collar Defined option provides the option to designate a beacon as collar defined which means that the beacon's interaction with a collar device is governed by configuration data maintained by the collar device as described above with respect to FIG. 4). The user may under an embodiment designate an Avoidance function at screen 630. The user is then presented at screen 640 with range and action options as seen in FIG. 6. The user manipulates interface selections to assign the collar a stimulus function when the collar is within a selected range (Level 1) of the beacon. Specifically the user selects a negative stimulus (applied by the collar) as an avoidance function and designates a corresponding range. The application interface may provide various stimulus functions (tone, stimulus, scent, etc.) and one or more ranges. Range Level 1 for example indicates close proximity to a beacon. Range Level 2 and Range Level 3 represent enlarged threshold distances. After selecting range and function, the user may be presented with another screen (not shown) allowing user to designate permitted access times, e.g. times during which the collar does not apply the designated function when the collar device in within the designated range. Embodiments are not limited to the functions and ranges described in FIG. 6. Once the configuration selections are complete for a beacon, the application may prompt the user to bring the application in proximity to the beacon. The application may then transmit such configuration data (including function data, distance data, and permitted times data) to the beacon. The beacon encodes the particular configuration data into packets for inclusion in the beacon's periodic transmissions. Accordingly, the beacon periodically transmits both its identification number and the configuration data to devices within its range. In this manner a user may assign a function directly to each beacon within the system. Under an embodiment, the application also transmits the unique identification number of the particular configured beacon to the collar device. In this manner, the collar device may monitor incoming beacon transmissions and confirm that the beacon is part of the configured system under this embodiment.

As indicated above, a user may use the application interface during setup to assign an avoidance function to a beacon directly. During set up operations, the application transmits such configuration data to the specifically tasked beacon. (It should be noted beacons not only transmit data, they may also receive and store data from other beacons or devices). The transmitted data includes “function data” (which encodes the particular function in data packets for inclusion in the beacon's periodic transmissions), threshold distance (and permitted time data under an embodiment). The application may also send the beacon's identification number to the collar device which stores such information. Accordingly, the beacon periodically transmits its identification number, the function data, and a threshold distance (and permitted times under an embodiment) to devices within its range. Under this example, the pet collar device may approach the beacon transmitting the identification number and corresponding data. The collar device then extracts the identification number, the “function data”, distance data (and permitted time data under an embodiment) and uses the signal strength of the transmission to estimate distance from the beacon. The collar device may match the identification number to stored beacon identification numbers to ensure that the particular beacon is part of the configured system, i.e., that the collar device should proceed. The collar device may then match “function data” with function type, e.g. avoidance, tracking, etc., using embedded code within a pet collar. Alternatively, a smartphone application may transmit such data to the collar device during set up operations. Under this example, the function data corresponds to an avoidance task, i.e. delivery of negative stimulus. The collar device then resolve whether the device is within the designated threshold distance (and within appropriate time interval under an embodiment). If so, the collar device executes the assigned function, i.e. delivers the negative stimulus.

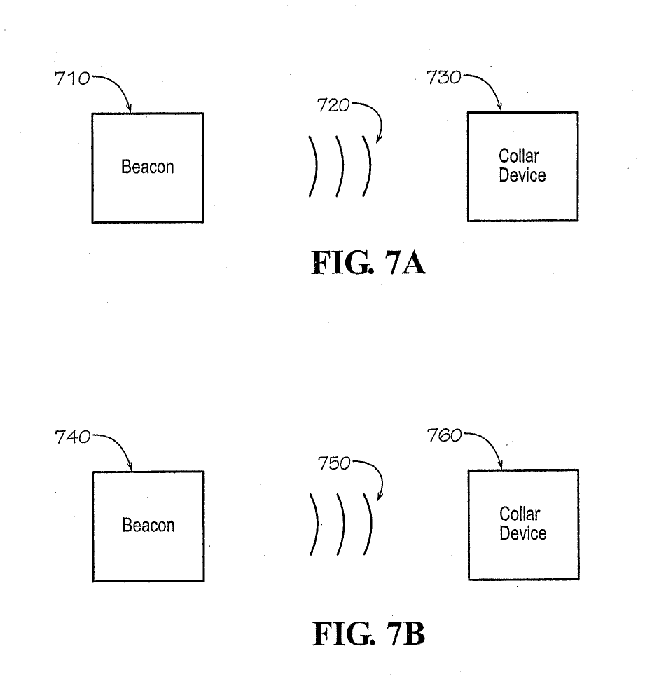

FIG. 7A shows a beacon defined embodiment of beacon/device functionality. Under this embodiment, the beacon 710 transmits 720 its identification number, a distance range (e.g., nearby range) and function data. (It should be noted that distance range may comprise distance from a location or a range of such distances including an upper and lower boundary). The collar devices uses signal strength to estimate distance from the transmitting beacon. The collar device 730 extracts function data (corresponding to negative stimulus) and distance range information from the signal. The collar device interprets the function data as a negative stimulus function, and if the collar device determines that the collar device is within a near range distance, then the collar device applies the negative stimulus. The collar device may also log the time/duration of the event along with corresponding identification number of the beacon.

FIG. 7B shows a collar defined embodiment of beacon/device functionality. Under such embodiment, the beacon 740 (located near a couch) simply transmits 750 its unique identification number. The collar device 760 then detects the transmission, identifies the identification number and uses signal strength to estimate distance from the transmitting beacon. The collar device then uses the identification number to look up configuration data. Under this embodiment, such data comprises an avoidance function (i.e., negative stimulus), and a midrange distance. (It should be noted that distance range may comprise distance from a location or a range of such distances including an upper and lower boundary). If the collar device determines that the device is within a midrange distance, then the collar device applies the negative stimulus. The collar device may also log the time/duration of the event along with corresponding identification number of the beacon.

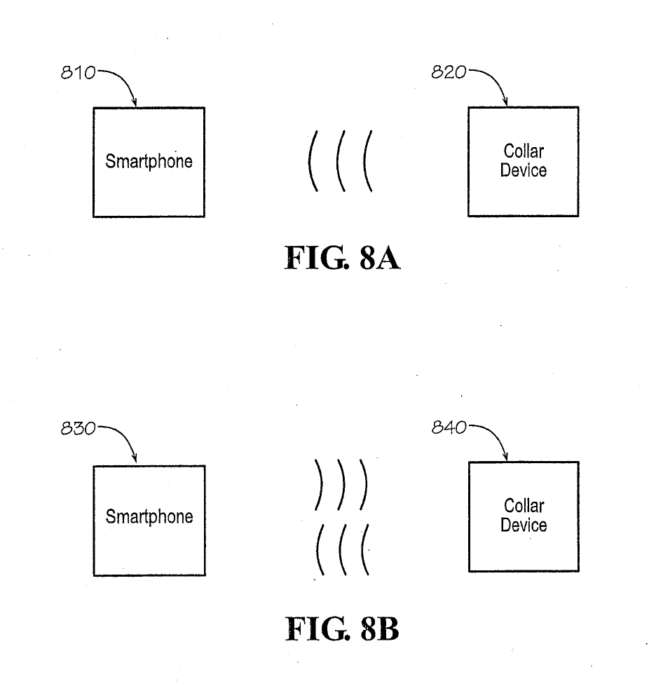

FIG. 8A shows a collar device 820 transmitting data to a smartphone 810 under one embodiment. FIG. 8B shows two way communication between a collar device 840 and a smartphone 830 under one embodiment.

Under one embodiment, a home detection kit may ship with a collar and corresponding beacons. A user may first register the smart phone application with a company provided internet service. Registration may provide the application with the unique device identification numbers of the beacons and the collar(s). Alternatively, the application may discover identification numbers during configuration as described in detail above.

Under one embodiment, a pet owner/user deploys beacons in a home. The user simply locates beacons in areas of interest. The pet owner uses a collar, in conjunction with a smartphone application to assign “Avoid” and/or “Track” functions to collar/beacon combinations. As an example of assigning an “Avoid” function (using the procedures already described in detail above), a user first places a red sticker on a beacon. The user then approaches the beacon with a mobile device running the smartphone application. The application/device reads the unique identification of the beacon and reads receiver signal strength indication (RSSI) value. The application then communicates with the collar to assign collar a function of the particular beacon when the pet collar is within a set range of the beacon. If the pet collar comes within a configured distance of the particular beacon, the collar triggers a negative stimulus and stores the time of the event under an embodiment.

As an example of assigning a “Track” function (using the procedures already described in detail above), a user first places a green sticker on beacon. The user then approaches the beacon with a mobile device running the smartphone application. The application/device reads the unique identification of the beacon and reads receiver signal strength indication (RSSI) value. The application then communicates with the collar to assign collar a function of the particular beacon when the pet collar is within a set range of the beacon. If the pet collar comes within a configured distance of the particular beacon, the collar will log the occurrence of the event and/or emit a positive reinforcement stimulus under an embodiment. The collar may also store the time of the event.

As the pet wearing the collar moves about the home, the collar collects data while controlling the pet's whereabouts through stimulus events triggered by proximity to “red” beacons and tracked events triggered by proximity to “green” beacons. When the collar is within range of the smart phone application, the collar transmits all collected/queued data to the application which may then display such information. A user may also deliver immediate Avoid/Track commands to the collar.

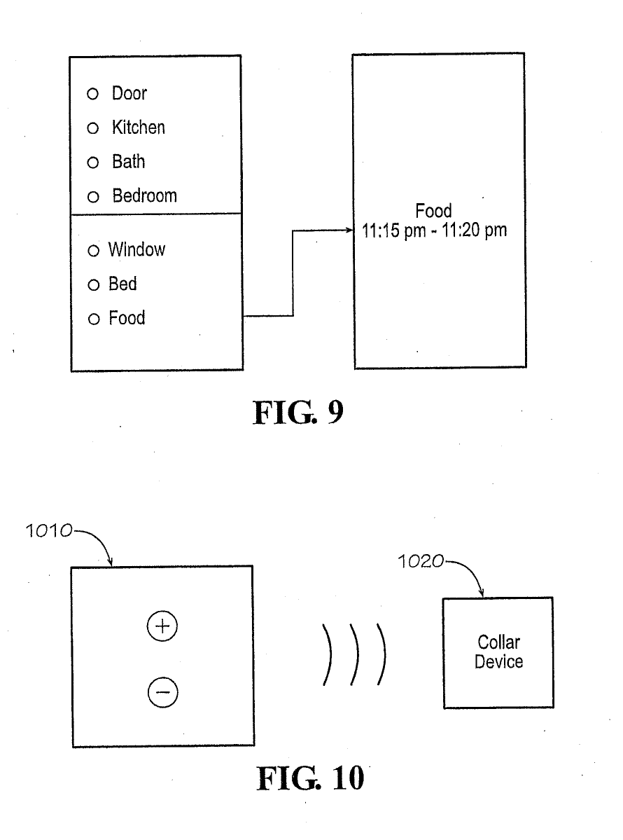

FIG. 9 shows an application interface allowing user a selection among beacon locations. A user may select “Food” which then directs user to another page featuring tracking data. In this example (as seen in FIG. 9), the interface shows that the user's pet was within a configured range of the pet's water bowl from 11:15-11:20 pm.

FIG. 10 shows a “Remote Trainer” interface page of an application running on a smartphone 1010. A user may select the “+” button to direct the collar 1020 to administer a positive stimulus. A user may select the “−” button to direct the collar 1020 to administer a negative stimulus.

Under one embodiment, Bluetooth LE modules are used in the beacons and collars of the systems and methods described above. Alternatively, unique RF beacons may be specially designed for this detection/tracking/monitoring system described herein.

Under one embodiment, one or more of a pet collar device, a beacon, and smartphone may be communicatively coupled via Wi-Fi or WPAN communications protocols to a local router to provide a communicative coupling with wide area networks, metropolitan area networks and with the internet in general. Each such device therefore is communicatively coupled to a remote cloud computing platform comprising one or more applications running on at least one processor of a remote server. Accordingly, the collar/beacons/smartphone may transmit data to and/or receive data from a cloud computing platform.

Under one embodiment, beacons may comprise a green and red side. If placed with green side up, the beacon may be automatically configured as a “Track” location. If placed with red side up, the beacon may be automatically configured as an “Avoid” location.

It is understood that the systems and method described herein are merely illustrative. Other arrangements may be employed in accordance the embodiments set forth below. Further, variations of the systems and method described herein may comply with the spirit of the embodiments set forth herein.

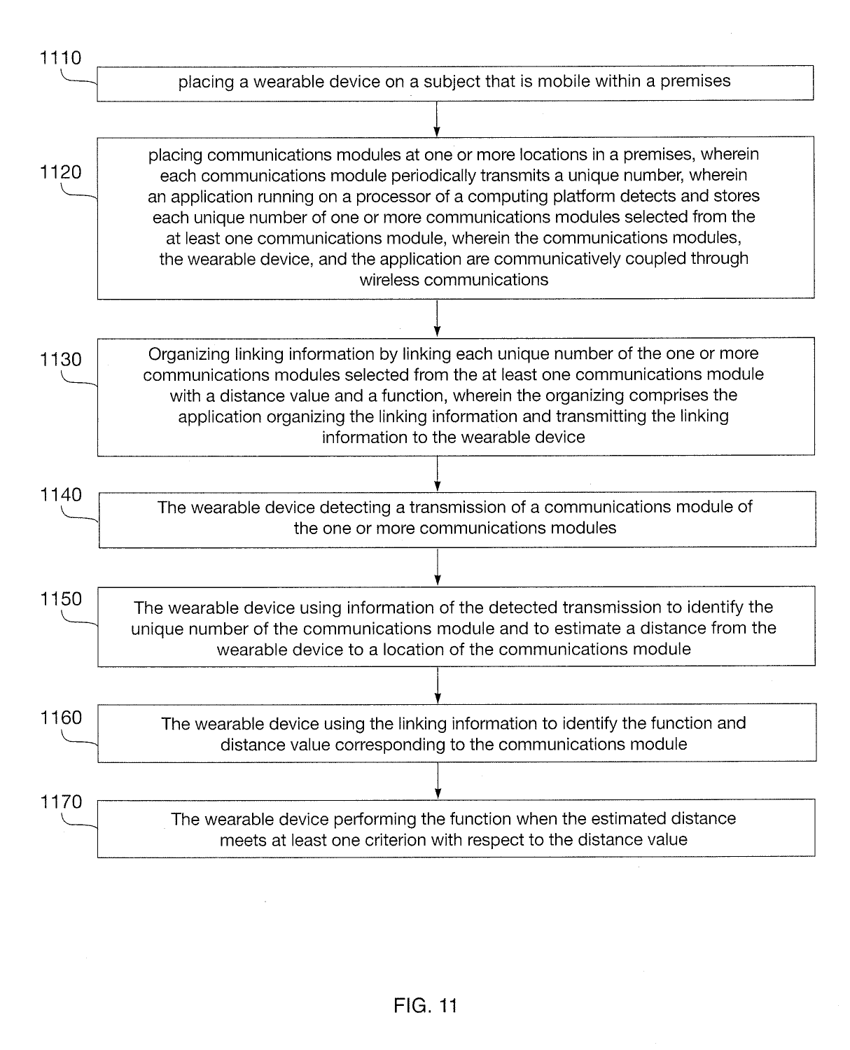

FIG. 11 comprises a method monitoring a subject in a premises, under an embodiment. Step 1110 includes placing a wearable device on a subject that is mobile within a premises. Step 1120 includes placing communications modules at one or more locations in a premises, wherein each communications module periodically transmits a unique number, wherein an application running on a processor of a computing platform detects and stores each unique number of one or more communications modules selected from the at least one communications module, wherein the communications modules, the wearable device, and the application are communicatively coupled through wireless communications. Step 1130 includes organizing linking information by linking each unique number of the one or more communications modules selected from the at least one communications module with a distance value and a function, wherein the organizing comprises the application organizing the linking information and transmitting the linking information to the wearable device. Step 1140 includes the wearable device detecting a transmission of a communications module of the one or more communications modules. Step 1150 includes the wearable device using information of the detected transmission to identify the unique number of the communications module and to estimate a distance from the wearable device to a location of the communications module. Step 1160 includes the wearable device using the linking information to identify the function and distance value corresponding to the communications module. Step 1170 includes the wearable device performing the function when the estimated distance meets at least one criterion with respect to the distance value.

Systems and methods for monitoring a subject in a premises are described above in detail. In accordance with such disclosure, FIG. 2 shows one embodiment of a system for monitoring/tracking/detecting activities of a subject within a premises. FIG. 2 shows a mobile device 210 running a smartphone application. The smartphone application is communicatively coupled to collar devices 220, 230. The smartphone application may transmit data to and control certain functions of the collar devices 220, 230 as described above. The smartphone application may also receive data from collar devices as described above. FIG. 2 shows collar devices 220, 230 communicatively coupled to beacons 240, 250, 260. The collar devices receive data periodically transmitted by beacons 240, 250, 260 and otherwise communicate with beacons 240, 250, 260 as described above. The smartphone application 210 may assign certain functionality directly to beacons 240, 250, 260 and otherwise communicates with beacons as described above.

Under the embodiment described above, a monitoring/tracking/detection system includes one or more collar devices, one or more beacons, and at least one smartphone running an application and providing user interaction with such system. However, an additional embodiment of the monitoring/tracking/detection system may include additional sensors or devices that proactively monitor and manage the health and well being of a subject under observation within the protected/monitored premises. These additional sensors/devices include collar device sensors, environmental sensors, and action or activity sensors. However, it should be noted that these additional sensors/devices of a monitoring/tracking/detection system may represent one or more components from any single sensor/device category or from any combination of sensor/device categories.

Collar Device Sensors

The collar device itself may include sensing devices for monitoring the health and well being of a subject wearing the collar device. These sensing devices may monitor biological and physiological metrics of a subject wearing the collar device. The sensing devices may also monitor motion and activity parameters of a subject wearing the collar device. The subject may comprise an animal but embodiments are not so limited. Under this embodiment, the collar device includes one or more of the following monitoring/sensing devices:
the collar device may include a heart rate sensor for monitoring heart rate.
the collar device may include an Electrocardiogram to monitor a heart's electrical activity (EKG or ECG).
the collar device may include one or more blood pressure sensors to monitor blood pressure levels.
the collar device may include one or more respiration rate sensors for monitoring respiration rates.
the collar device may include one or more temperature sensors for monitoring body temperature.
the collar device may include an accelerometer and/or gyroscope in order to monitor activity levels and activity types.

It should be noted that a collar device is not limited to traditional configurations of a collar. Rather, a collar device may comprise any wearable device that may position sensor devices at various physical locations on the subject wearing the device.

Environmental Sensors

Environmental sensors may be distributed throughout the premises of a monitoring/tracking/detection system. These sensors monitor and detect environmental parameters of a premises. Environmental sensors may include temperature sensors, moisture sensors, humidity sensors, air pressure sensors and/or air quality condition sensors. However, a monitoring/tracking/detection system may clearly incorporate fewer or additional numbers and types of environmental sensors. Such environmental sensors may be directly attached to or incorporated within a beacon. Under this embodiment, environmental sensors are electronically connected to a beacon. Alternatively, environmental sensors may be located in proximity to beacons. Under this embodiment, environmental sensors may be in wired or wireless communication with beacons. Under another embodiment, environmental sensors may be located in a position to detect an overall condition of an environment. Under the embodiments described above, environmental sensors (i) may communicate directly with a collar device or (ii) may communicate with a collar device through an intermediate beacon device. Environmental sensors are Bluetooth enabled under an embodiment and capable of Bluetooth Low Energy protocol communications.

Activity Devices

Activity or action devices may be distributed throughout the premises of a monitoring/tracking/detection system. Under one embodiment, an activity device may be electrically connected to or incorporated within another device. For example, activity devices may represent switches which control the operation or function of yet other devices, e.g. the flow of water in a dispensing device, the management of food volume/type in a food dispensing device, etc. Further, an activity device may represent a switch that monitors thermostat levels. As another example, an activity device may itself comprise a toy or audio playback device. Such devices are Bluetooth enabled under an embodiment and capable of Bluetooth Low Energy protocol communications.

Of course it should be noted that fewer or additional numbers and/or types of collar device sensors, environmental devices and activity devices may be included in the monitoring/tracking/detection system of an embodiment.

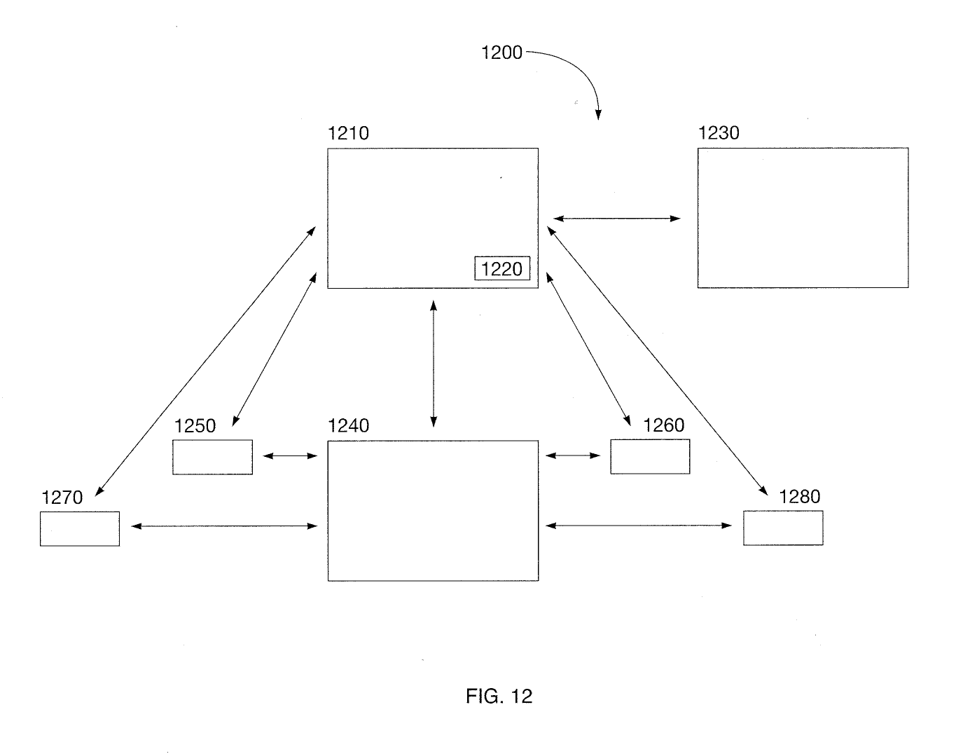

FIG. 12 shows the components of a monitoring/tracking/detection system including the additional devices and sensors that provide pro-active health and well being functionality under one embodiment. The wireless network 1200 of FIG. 12 comprises under one embodiment a collar device 1210, a beacon device 1240, and a mobile device 1230 running a smartphone application. The collar device includes collar device sensors 1220. FIG. 12 shows environmental sensor 1250 communicatively connected with beacon 1240 and environmental sensor 1260 communicatively connected with beacon 1240. FIG. 12 also shows activity device 1270 communicatively connected with beacon 1240 and activity device 1280 communicatively connected with beacon 1240. FIG. 12 also shows that environmental sensors 1250, 1260 and activity devices 1270, 1280 may be directly communicatively connected with a collar device 1210 and may also communicate with the collar device 1210 through beacon 1240. The mobile device of FIG. 12 is communicatively coupled with components 1240, 1250, 1260, 1270, and 1280 through wireless network 1200.

Note that FIG. 12 shows the components of a monitoring/tracking/detection system that includes a single beacon and a single collar device. Of course, such system may include a plurality of beacons and a plurality of collar devices. Further note that FIG. 12 discloses environmental sensors positioned in a location remote to the beacon. Alternatively, the beacon itself includes one or more environmental sensors. Under this embodiment, such environmental sensors are electronically connected to and incorporated within the beacon. Further, FIG. 12 shows a monitoring/tracking/detection system featuring collar device sensors, environmental sensors, and activity devices. However, a monitoring/tracking/detection system may include any individual or combined use of sensors/devices from any sensor/device category (i.e. collar, environmental, or activity) or any combination of categories.

Operation of a “pro-active health and well being” monitoring/tracking/detection system involves the interaction of Bluetooth enabled collar device sensors, environmental sensors and/or activity devices. As indicated above, the collar device itself includes sensors that monitor biological, physiological, and motion parameters of a subject roaming the environment of a monitored premises. The environmental sensors simultaneously monitor and detect the environmental conditions of the premises. Each environmental sensor then periodically transmits such monitored/detected data. Each such environmental sensor may pair (or be associated) directly with a corresponding beacon, i.e. a particular beacon may detect, receive and store data periodically transmitted by an associated environmental sensor data. The beacon may then bundle the received sensor data into its own periodic broadcast transmissions. Recall from the discussion above that beacons and collar devices interact within a premises under a collar defined mode or beacon defined mode. Under a collar defined mode, a beacon periodically transmits an identification number (along with other data). A collar moving within communications range of a beacon receives the transmission and extracts the identification number. The collar device then uses internal data tables to match the identification number with avoidance/interaction functions. Alternatively, the beacon may itself determine the behavior of the collar device, i.e. the beacon may transmit identification and function data to an “in range” collar device. Under either configuration, a beacon may simply incorporate collected environmental sensor data into its periodic transmission such that “in range” collar devices in turn detect environmental sensor data associated with a particular beacon. Alternatively, each environmental sensor may periodically transmit data for detection by any “in range” collar device roaming within the wireless communications network of the overall monitoring/tracking/detection system. Environmental sensor transmissions may under an embodiment include unique identification numbers for use by components of a monitoring/tracking/detection system

Environmental sensors may be associated with particular beacons or may be positioned to monitor an overall environmental condition of a premises. In this manner, environmental sensors may monitor micro-environmental conditions near or with respect to particular beacons or macro-environmental conditions within a premises.

In operation of a “proactive health and well-being” monitoring/tracking/detection system, a collar device collects a wealth of information as it roams throughout the monitored premises. First, the collar device may collect data with respect to avoidance/tracking events (otherwise referred to herein as avoidance/interaction events) triggered by proximity to particular beacons. (Note that avoidance/tracking events and the logging of information related thereto are disclosed in great detail above). Second, the collar device includes one or more sensors for monitoring/tracking/detecting physiological and motion metrics associated with a subject wearing the collar. Third, the collar device detects and receives data from environmental sensors that are (i) distributed throughout the premises and/or (ii) located within a beacon. The collar device may collect and process avoidance/interaction data, collar device sensor data (including physiological and motion activity data of a subject wearing the collar), and/or environmental sensor data to determine particular needs. As just one example and as further described below, the combination of avoidance/interaction data, physiological condition data, and/or environmental sensor data may indicate that an animal wearing the collar is not eating or drinking appropriate quantities of food/water.

Based on a determination of need, i.e. the need to induce increased intake of food/water, the collar device may interact with action or activity devices distributed throughout the premises, i.e. the collar device may activate functional changes in activity devices in order to address the need. For example, an activity device may represent Bluetooth enabled switches which control the operation or function of yet other devices. For example, if the collar device determines a need to induce increased intake of water, the collar device may communicate with a Bluetooth enabled switch that toggles a fountain motor of a water bowl. The communication may activate the fountain motor in order to encourage drinking of water. Under this embodiment, the collar device is communicatively coupled to the activity device through the WPAN network described above with respect to FIG. 12. The collar device may exchange data directly with activity devices or may communicate with activity devices through beacons associated or paired with such activity devices.

As indicated above, a collar device may collect and process avoidance/interaction data, collar device sensor data (including physiological conditions and motion activity of a subject wearing the collar), and environmental sensor data to determine particular needs. It should be noted that a collar device may determine a need using any single type of data, i.e. avoidance/interaction, collar device sensor, and environmental, or using any combination of data types. Once a need is determined, the collar device may determine and direct functional changes of activity devices within the premises of a monitoring/tracking/detecting system. The collar device may exchange data directly with action/activity devices or may communicate with action/activity devices through beacons associated or paired with such activity devices. Accordingly, data collection and analysis may be conducted by a collar device. However, data collection and analysis may also take place at a cloud computing level.

As described above with respect to FIG. 12, a pet collar device, beacons, smartphone, environmental sensor and activity devices may be communicatively coupled via WPAN compatible communications (e.g. Bluetooth communications protocols under an embodiment) to a local router or communications hub providing a communicative coupling with wide area networks, metropolitan area networks and with the broader internet in general. Each such networked device within the monitoring/tracking/detection system may therefore be communicatively coupled to a remote cloud computing platform comprising one or more applications running on at least one processor of a remote server. Accordingly, the collar/beacons/smartphone, environmental sensors, and/or activity devices may transmit data to and/or receive data from a cloud computing platform. Under this embodiment, a collar device may collect and forward avoidance/interaction data, collar device sensor data (including physiological conditions and/or motion activity of a subject wearing the collar), and/or environmental sensor data. In other words, a collar device may collect and forward such data to a remote application running on a remote computing platform which may then itself analyze the data to determine a particular need of a subject wearing the collar device. Once a need is determined, the remote application may determine and direct functional changes of activity devices within a premises of a monitoring/tracking/detecting system. The remote application may communicate with a collar device which then transmits function change information to activity devices to trigger actions designed to address the identified need (as described above). Alternatively, the remote application may communicate functional change information directly to beacons which then communicate with and control activity devices accordingly. Further, the remote application may communicate directly with activity devices.

As described above, the collar/beacons/smartphone, environmental sensors, and/or activity devices may transmit data to and/or receive data from a cloud computing platform. Under this embodiment, a collar device may collect and forward avoidance/interaction data, collar device sensor data (including physiological conditions and/or motion activity of a subject wearing the collar), and/or environmental sensor data. In other words, a collar device may collect and forward such data to a remote application running on a remote computing platform. The remote application may then transmit this data to an application running on a smartphone or other mobile computing platform. The smartphone application may then analyze the data to determine a particular need of a subject wearing the collar device. Once a need is determined, the smartphone application may determine and direct functional changes of activity devices within a premises of a monitoring/tracking/detecting system. The smartphone application may then transmit functional change information to the remote application running on at least one processor of a remote server.

Under one embodiment, the smartphone application determines a need based on any single type of data, i.e. avoidance/interaction, collar device sensor, and environmental, or based on any combination of data types. The smartphone application may present the user an interface alerting the user of any currently identified need. The interface may also recommend a course of action to address the need, i.e. recommend particular action or operation of an activity device to address the need. The user may select or ignore recommend courses of action. The smartphone application may then communicate function change information to the remote computing platform which may then process such information in a manner already described above.

The user may use the smartphone application to configure automated cloud computing platform or collar device responses to identified needs. As already indicated above, a collar device, remote computing platform, or smartphone application may analyze avoidance/interaction data, collar device sensor data, and/or environmental sensor data. A collar device, remote computing platform, or smartphone application may determine a need using any single type of data, i.e. avoidance/interaction, collar device sensor, and environmental, or using any combination of data types. In other words, a need may comprise any single instance or combination of avoidance/interaction data, collar device sensor data, and environmental data. The user may use the smartphone application to associate activity device action with defined instances or combinations of avoidance/interaction data, collar device sensor data, and environmental data. The smartphone application, collar device or remote computing platform may then automatically apply remedies, i.e. activity device action, upon detection/identification of corresponding needs.

The smartphone application may provide the user with remote activity device control. As opposed to automating activity device responses and as opposed to accepting or rejecting activity device recommendations, the user may simply manually control premises activity devices. As already indicated above (and further described in great detail below), the user may be alerted of premises activity, i.e. detected/identified needs, through a smartphone application interface. The user may then manually direct in premises activity devices to perform specific functions or operations in order to address the detected/identified need.

The following disclosure provides Use Case Examples of a “proactive health and well-being” monitoring/tracking/detection system. For purposes of providing the Use Case Examples, assume the collar device includes the following sensors for measuring biological and physiological metrics of a subject wearing the collar device: Heart Rate Sensor, Electrocardiogram, Blood Pressure Sensor, Respiration Rate Sensor and Temperature Sensor. Such devices indicate physiological conditions in real time. The collar device may also include an Activity Monitor (e.g. accelerometer and gyroscope) which indicates real time physical activity levels of the subject wearing the collar device. Further with respect to the Use Case Examples described below, assume that environmental sensors are distributed throughout a premises of a monitoring/tracking/detection system. With respect to the examples provided below, environmental sensors include temperature, moisture, humidity, air pressure and/or air quality condition sensors. In addition, activity devices are also distributed throughout the premises. Activity devices may control the function, operation, or performance of additional devices. For example, an activity device may control the level of a thermostat or a dispensing mechanism of a food/water dispenser. As already described in great detail above, a collar device (including collar device sensors), beacons, environmental sensors, and activity devices are communicatively coupled through a Wireless Personal Area Network (WPAN). Under this embodiment, the WPAN enables wireless communications among such devices using Bluetooth Low Energy communication protocols. It should be noted that Use Case Examples may include additional types and numbers of collar sensors, environmental sensors and activity devices as required by the particular example.

### Use Case Example

The collar device receives, monitors and collects avoidance/interaction data, collar device sensor data (including physiological condition data and activity level data), and/or environmental sensor data. The collar device may combine a subset of physiological conditions, physical activity levels, environmental sensor data, and/or interaction events (with respect to food and water bowls) to determine if intake requirements are being met. If not, then . . .
the collar device may trigger a water dispensing device to encouraged drinking with the addition of flavorings;
the collar device may encourage drinking of water by activating a fountain motor;
the collar device may trigger dispensing of treats by food dispensing device to encourage eating.

### Use Case Example

The collar device receives, monitors and collects avoidance/interaction data, collar device sensor data (including physiological condition data and activity level data), and/or environmental sensor data. Accordingly, the collar device may monitor the physical activity sensor to determine if too much or too little physical activity is occurring. If change is needed, then . . .
the collar device may active toys (i.e., activity devices) to encourage activity;
the collar device may communicate with temperature control devices to adjust temperature so as to encourage or discourage activity;
the collar device may activate audio playback devices to provide calming or stimulating environmental sounds, noises, tones, music, etc.
the collar device may communicate with activity devices that control opening/closing of doors, i.e. doors may be locked or unlocked to encourage or discourage physical activity in proximity to a given beacon.

### Use Case Example

The collar device receives, monitors and collects avoidance/interaction data, collar device sensor data (including physiological condition data and activity level data), and/or environmental sensor data. Accordingly, the collar device may monitor the number of avoidance events encountered. If a limit is exceeded, then . . .
the collar device may communicate with and activate toys to encourage wearer of the collar device to engage in alternative activities.
the collar device may trigger treat dispensers to dispense treats as a distraction.

### Use Case Example

The collar device receives, monitors and collects avoidance/interaction data, collar device sensor data (including physiological condition data and activity level data), and/or environmental sensor data. Accordingly, the collar device may monitor a subset of physiological conditions and physical activity levels to determine if medicine should be introduced. If so, the collar device may cause an automatic dispenser to release medication.

### Use Case Example

The collar device receives, monitors and collects avoidance/interaction data, collar device sensor data (including physiological condition data and activity level data), and/or environmental sensor data. Accordingly, a collar device may process data from a water bowl sensor indicating the water bowl level. If the level indicates low levels, then the collar device may communicate with and command a valve to open within the water bowl to refill (i.e. increase) the water level.

### Use Case Example

The collar device receives, monitors and collects avoidance/interaction data, collar device sensor data (including physiological condition data and activity level data), and/or environmental sensor data. Accordingly, a collar device may receive/process data from a food dispenser sensor indicating that the food dispenser is in a jammed state. The collar may then report the condition to at least one application running on a remote server, i.e. the cloud computing platform. In turn the cloud computing platform may use general internet connectivity to forward alerts regarding the condition to a smartphone application. The cloud computing platform may provide such alerts via text message, email, or smartphone application interface. In such manner, a user may remotely monitor the status of the food dispenser.

### Use Case Example

The collar device receives, monitors and collects avoidance/interaction data, collar device sensor data (including physiological condition data and activity level data), and/or environmental sensor data. Accordingly, a collar device may process data from a body weight scale. If the weight is above or below an ideal value, then . . .
the collar device may communicate with and activate toy (i.e., activity) devices within the premises to encourage activity while also monitoring subject response using collar device activity monitor;
the collar device may interact with food dispenser to limit the amount of food dispensed via a feeder if the measured weight is too high; alternatively the collar device may interact with food dispenser to provide excessive food amounts if the measured weight is too low;
the collar device may interact with a food weight scale to monitor the actual amount of food consumed;
the collar device may monitor subject response to the environmental changes via the physiological sensors within the collar.

### Use Case Example

The collar device receives, monitors and collects avoidance/interaction data, collar device sensor data (including physiological condition data and activity level data), and/or environmental sensor data. Accordingly, the collar device may process data from a noise monitor sensor within the premises. If the noise level is over a prescribed limit, then . . .
the collar device may communicate with and activate toys to provide a distraction;
the collar device may communicate with and activate a treat dispenser to provide a distraction;
the collar device may communicate with and activate an Active Noise Cancellation system to minimize noise level.

### Use Case Example

The collar device receives, monitors and collects avoidance/interaction data, collar device sensor data (including physiological condition data and activity level data), and/or environmental sensor data. Accordingly, the collar device may monitor and process data from co-located biological sensors indicating health status. Such sensors may be external to the subject and may monitor biological features of a subject from a distance. The collar may then report the monitored features to at least one application running on a remote server, i.e. the cloud computing platform. In turn the cloud computing platform may use general internet connectivity to forward alerts regarding such features to a smartphone application. The cloud computing platform may provide such alerts via text message, email, or smartphone application interface.

It should be noted that in the Use Case Examples provided above, the collar device analyzes avoidance/interaction data, collar device sensor data, and environmental sensor data to identify conditions and needs within the monitored premises. The collar device may then communicate with and command activity devices to perform certain functions to address such need or condition. In each Use Case Example, the collar device may then report the conditions, needs, and actions to at least one application running on a remote server, i.e. the cloud computing platform. In turn the cloud computing platform may use general internet connectivity to forward conditions, needs, and actions in the form of alerts or notifications to a smartphone application. The cloud computing platform may provide such alerts or notifications via text message, email, or smartphone application interface. In such manner, a user may remotely monitor the status of a monitoring/tracking/detecting system in real time.

It should be noted that in the Use Case Examples above, the collar device collects and analyzes avoidance/interaction data, collar device sensor data (including physiological conditions of a subject wearing the collar), and environmental sensor data in order to determine needs. The collar device then interacts with action/activity devices to address the need. However, the collar device may simply collect and forward such critical data to a remote application running on a remote computing platform which may then analyze the data to determine a particular need of a subject wearing the collar device. Once a need is determined, the remote application may determine and direct functional changes of activity devices within a premises of a monitoring/tracking/detecting system. The remote application may communicate with a collar device which then transmits function change information to activity devices to trigger actions designed to address the identified need. Further (and as already described above), the smartphone application may itself analyze collar device, environmental, and/or avoidance interaction data to diagnose needs and may itself direct function changes within the premises.

It should be noted that in the disclosure and examples provided above, activity devices generally control operation and performance of certain other devices with the monitored premises. However, such activity devices may themselves function as environmental sensors in the embodiments described above.

The wireless network of FIG. 12 may comprise a Wireless Personal Area Network (WPAN). A wireless personal area network (WPAN) is a personal area network for interconnecting devices usually centered within an individual person's living space or workspace. A wireless PAN is based on the standard IEEE 802.15. One type of wireless technology used for a WPAN includes the Bluetooth low energy (BLE) standard for personal area networks. Bluetooth low energy communication uses short-range radio waves to connect devices such as keyboards, pointing devices, audio headsets, printers, laptops, computers, embedded microcontrollers, personal digital assistants (PDAs), smart phones, tables, routers, sensor devices, monitoring devices, smart televisions, and streaming devices. Alternatively, a WPAN may also enable communications among networked components using Wireless USB, Zigbee or Z-Wave communication protocols. WPANs can be used for communication among the personal devices themselves (intrapersonal communication), or for connecting to a higher level network and the Internet (an uplink).

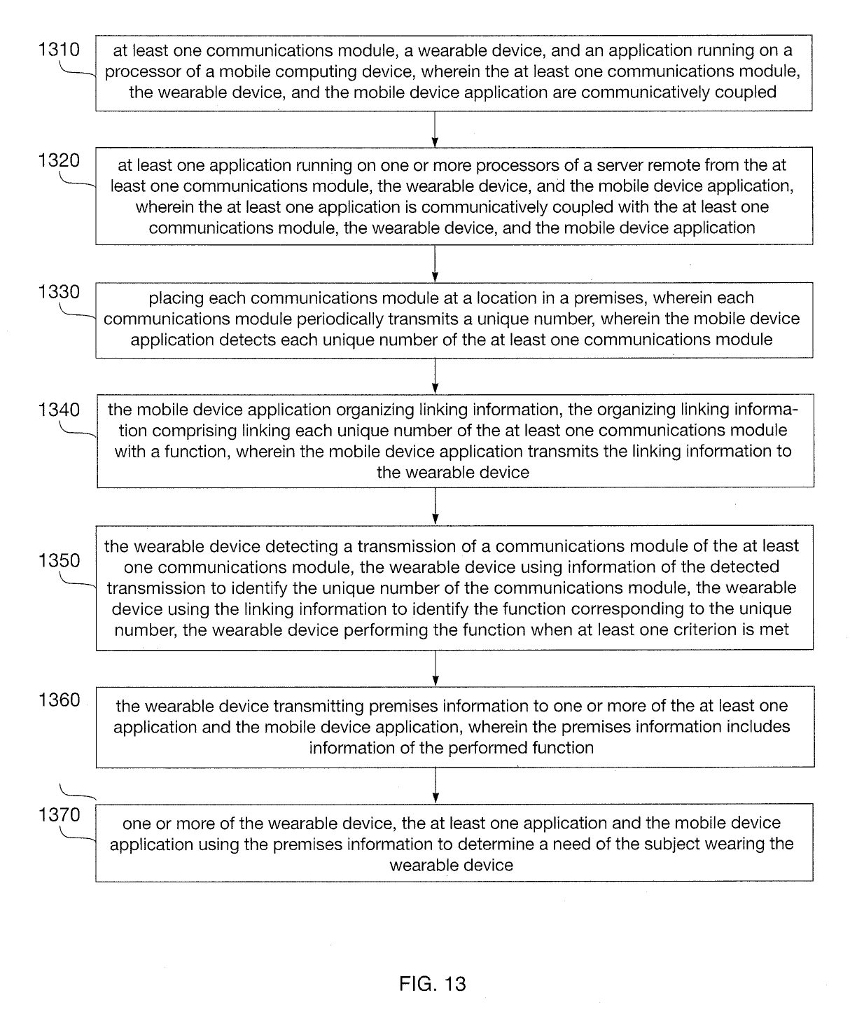

FIG. 13 shows a system for monitoring a subject in a premises. The system includes 1310 at least one communications module, a wearable device, and an application running on a processor of a mobile computing device, wherein the at least one communications module, the wearable device, and the mobile device application are communicatively coupled. The system includes 1320 at least one application running on one or more processors of a server remote from the at least one communications module, the wearable device, and the mobile device application, wherein the at least one application is communicatively coupled with the at least one communications module, the wearable device, and the mobile device application. The system includes 1330 placing each communications module at a location in a premises, wherein each communications module periodically transmits a unique number, wherein the mobile device application detects each unique number of the at least one communications module. The system includes 1340 the mobile device application organizing linking information, the organizing linking information comprising linking each unique number of the at least one communications module with a function, wherein the mobile device application transmits the linking information to the wearable device. The system includes 1350 the wearable device detecting a transmission of a communications module of the at least one communications module, the wearable device using information of the detected transmission to identify the unique number of the communications module, the wearable device using the linking information to identify the function corresponding to the unique number, the wearable device performing the function when at least one criterion is met. The system includes 1360 the wearable device transmitting premises information to one or more of the at least one application and the mobile device application, wherein the premises information includes information of the performed function. The system includes 1370 one or more of the wearable device, the at least one application and the mobile device application using the premises information to determine a need of the subject wearing the wearable device.

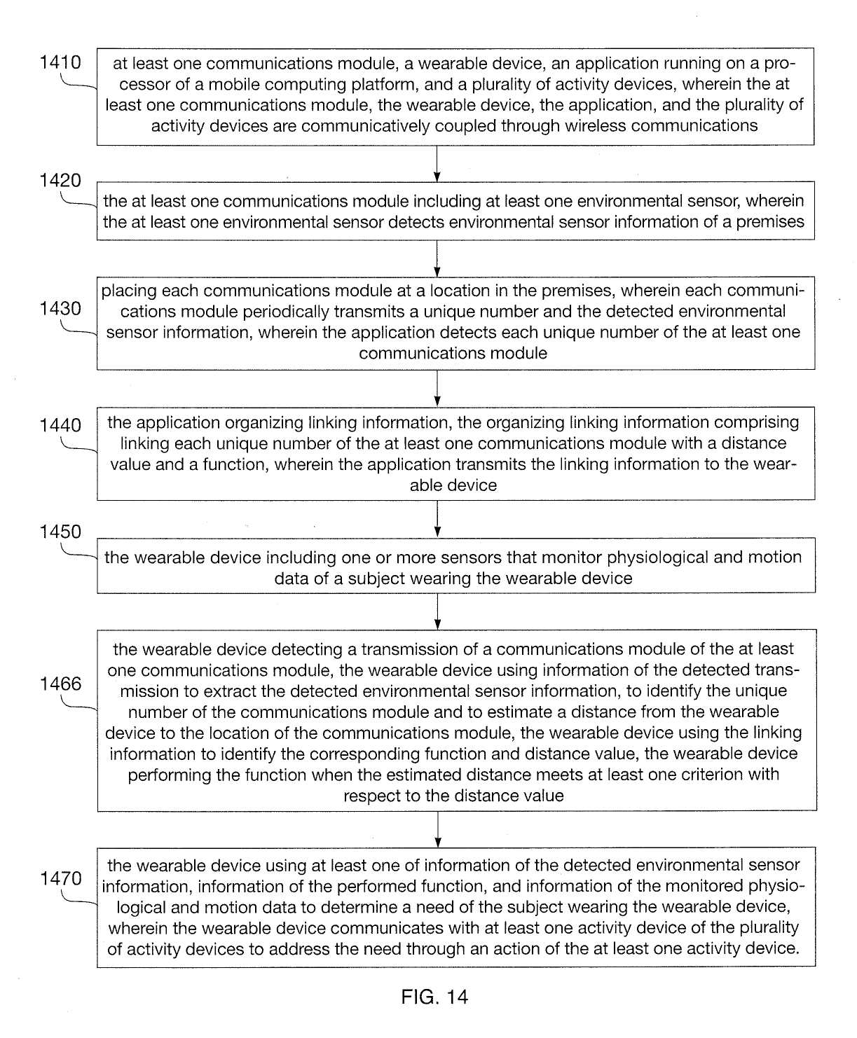

FIG. 14 shows a system for monitoring a subject in a premises. The system includes 1410 at least one communications module, a wearable device, an application running on a processor of a mobile computing platform, and a plurality of activity devices, wherein the at least one communications module, the wearable device, the application, and the plurality of activity devices are communicatively coupled through wireless communications. The system includes 1420 the at least one communications module including at least one environmental sensor, wherein the at least one environmental sensor detects environmental sensor information of a premises. The system includes 1430 placing each communications module at a location in the premises, wherein each communications module periodically transmits a unique number and the detected environmental sensor information, wherein the application detects each unique number of the at least one communications module. The system includes 1440 the application organizing linking information, the organizing linking information comprising linking each unique number of the at least one communications module with a distance value and a function, wherein the application transmits the linking information to the wearable device. The system includes 1450 the wearable device including one or more sensors that monitor physiological and motion data of a subject wearing the wearable device. The system includes 1460 the wearable device detecting a transmission of a communications module of the at least one communications module, the wearable device using information of the detected transmission to extract the detected environmental sensor information, to identify the unique number of the communications module and to estimate a distance from the wearable device to the location of the communications module, the wearable device using the linking information to identify the corresponding function and distance value, the wearable device performing the function when the estimated distance meets at least one criterion with respect to the distance value. The system includes 1470 the wearable device using at least one of information of the detected environmental sensor information, information of the performed function, and information of the monitored physiological and motion data to determine a need of the subject wearing the wearable device, wherein the wearable device communicates with at least one activity device of the plurality of activity devices to address the need through an action of the at least one activity device.

An embodiment of a system is described herein that comprises at least one communications module, a wearable device, and an application running on a processor of a mobile computing device, wherein the at least one communications module, the wearable device, and the mobile device application are communicatively coupled. The system includes at least one application running on one or more processors of a server remote from the at least one communications module, the wearable device, and the mobile device application, wherein the at least one application is communicatively coupled with the at least one communications module, the wearable device, and the mobile device application. The system includes placing each communications module at a location in a premises, wherein each communications module periodically transmits a unique number, wherein the mobile device application detects each unique number of the at least one communications module. The system includes the mobile device application organizing linking information, the organizing linking information comprising linking each unique number of the at least one communications module with a function, wherein the mobile device application transmits the linking information to the wearable device. The system includes the wearable device detecting a transmission of a communications module of the at least one communications module, the wearable device using information of the detected transmission to identify the unique number of the communications module, the wearable device using the linking information to identify the function corresponding to the unique number, the wearable device performing the function when at least one criterion is met. The system includes the wearable device transmitting premises information to one or more of the at least one application and the mobile device application, wherein the premises information includes information of the performed function. The system includes one or more of the wearable device, the at least one application and the mobile device application using the premises information to determine a need of the subject wearing the wearable device.

The organizing the linking information of an embodiment includes linking each unique number of the at least one communications modules with a distance value.

The wearable device of an embodiment uses information of the detected transmission to estimate a distance from the wearable device to the location of the communications module.

The wearable device of an embodiment uses the linking information to identify the corresponding distance value.

The meeting the at least one criterion comprises under an embodiment the estimated distance being less than the distance value.

The meeting the at least one criterion comprises under an embodiment the estimated distance being greater than the distance value.

The meeting the at least one criterion comprises under an embodiment the estimated distance being between a range of distance values.

The wearable device stores the linking information in a database under an embodiment.

The wearable device using the linking information comprising a database lookup under an embodiment.

The performed function comprises logging the information of the performed function under an embodiment.

The logged information includes under an embodiment one or more of a time, an occurrence, and a duration of the performed function.

The logging the information comprises under an embodiment associating the time and the occurrence with the unique number of the communications module.

The performed function comprises under an embodiment an avoidance function, wherein the avoidance function comprises applying a negative stimulus to a user of the wearable device.

The performed function comprises under an embodiment a tracking function, wherein the tracking function comprises applying a positive stimulus to a user of the wearable device.

The linking each unique number comprising under an embodiment linking each unique number with a permitted time, the wearable device using the linking information to identify the corresponding permitted time, wherein the meeting the at least one criterion includes a time of the performed function comprising the permitted time.

The linking each unique number under an embodiment comprising linking a first unique number with a first function and a first permitted time.

The linking each unique number under an embodiment comprising linking a second unique number with a second function, and a second permitted time.

The first function is different than the second function under an embodiment.

The first permitted time is different than the second permitted time under an embodiment.

The need of the subject wearing the device includes under an embodiment at least one of a need to modify levels of physical activity, a need to modify occurrences of the performed function, a need to modify environmental conditions, a need to control food consumption, a need to control water consumption, a need to receive medicine, a need to receive nutritional supplements, and a need to receive vitamins.

The premises includes under an embodiment one or more activity devices, wherein the one or more activity devices are communicatively coupled with the at least one communications module, the wearable device, the mobile device application, and the at least one application.

The one or more of the wearable device, the at least one application and the mobile device application determine under an embodiment at least one action of the one or more activity devices to address the need.

The one or more of the wearable device, the at least one application and the mobile device application communicate under an embodiment with the one or more activity devices to perform the at least one action.

The one or more activity devices include under an embodiment a device controlling thermostat levels, a device controlling lighting, a device controlling humidity levels, a device controlling operation and function of dispensing devices, a toy device, an audio playback device, a video playback device, a sound control device, and a gatekeeping device.

The at least one action includes under an embodiment the one or more activity devices controlling access to premises locations, adjusting dispensing levels of a food dispensing device, adjusting dispensing levels of a water dispensing device, adjusting temperature levels, adjusting humidity levels, adjusting lighting, adjusting sound levels, activating toy devices, controlling audio playback devices, controlling video playback devices and/or introducing medicines or vitamins through a dispensing device.

The one or more of the wearable device, the at least one application and the mobile device application under an embodiment use the premises information to generate alerts for delivery to an interface of the mobile device application.

The at least one communications module includes under an embodiment one or more environmental sensors.

The one or more environmental sensors of an embodiment collect environmental data of the premises under an embodiment.

The collected environmental data of the premises of an embodiment includes timing of occurrence with respect to the collected environmental data under an embodiment.

The premises information includes the collected environmental data under an embodiment.

Each communications module of an embodiment periodically transmitting the unique number includes periodically transmitting the collected environmental data, the using information of the detected transmission of an embodiment includes extracting the collected environmental data.

The one or more environmental sensors of an embodiment include at least one of a temperature sensor, a moisture sensor, a humidity sensor, an air pressure sensor, and an air quality sensor.

The wearable device of an embodiment includes one or more physiological sensors.

The one or more physiological sensors of an embodiment collect physiological data of the subject wearing the wearable device.

The collected physiological data of an embodiment includes timing of occurrence with respect to the collected physiological data.

The one or more physiological sensors of an embodiment include a heart rate sensor, electrocardiogram, a blood pressure sensor, a respiration rate sensor, and temperature sensor.

The premises information of an embodiment includes the collected physiological data.

The wearable device of an embodiment includes at least one activity sensor, wherein the at least one activity sensor collects motion and orientation data of the subject.

The premises information of an embodiment includes the collected motion and orientation data.

The motion and orientation data of an embodiment includes timing of occurrence with respect to collected motion and orientation data.

The at least one activity sensor of an embodiment includes an accelerometer and/or a gyroscope.

The premises of an embodiment includes at least one biological sensor located external to the subject wearing the collar device, the at least one external biological sensor collecting biological data of the subject.

The biological data of an embodiment includes timing of occurrence of the collected biological data.

The at least one external biological sensor of an embodiment includes a heart rate sensor, a respiration sensor, and a temperature sensor.

The premises information of an embodiment includes the collected biological data.

The at least one communications module, the wearable device, and the mobile device application are communicatively coupled under an embodiment through a Wi-Fi or WPAN enabled communications network.

The at least one communications module, the wearable device, and the mobile device application are under an embodiment communicatively coupled through a Wi-Fi or WPAN enabled communications network with at least one of a local area network (LAN), metropolitan area network (MAN), wide area network (WAN), the internet, a mobile network, and a cellular network.

The at least one application is under an embodiment communicatively coupled with the at least one of a local area network (LAN), metropolitan area networks (MAN), wide area network (WAN), the internet, a mobile network, and a cellular network

An embodiment of a system is described herein that includes at least one communications module, a wearable device, and an application running on a processor of a mobile computing device, wherein the at least one communications module, the wearable device, and the mobile device application are communicatively coupled. The system includes at least one application running on one or more processors of a server remote from the at least one communications module, the wearable device, and the mobile device application, wherein the at least one application is communicatively coupled with the at least one communications module, the wearable device, and the mobile device application. The system includes placing each communications module at a location in a premises, wherein the mobile device application transmits to the wearable device identification information, the identification information comprising a corresponding unique number for each communications module of the one or more communications modules, wherein the wearable device stores the identification information. The system includes the mobile device application transmitting data to the at least one communications module, the transmitting data including transmitting a function for each communications module of the at least one communications module. The system includes each communications module of the at least one communications module periodically transmitting a corresponding unique number and a corresponding function. The system includes the wearable device detecting a transmission of a communications module of the at least one communications module, the wearable device using information of the detected transmission to identify the unique number of the communications module and the transmitted function. The system includes the wearable device locating a presence of the unique number in the stored identification information, wherein upon the locating, the wearable device performs the function if at least one criterion is met. The system includes the wearable device transmitting premises information to one or more of the at least one application and the mobile device application, wherein the premises information includes information of the performed function. The system includes one or more of the wearable device, the at least one application and the mobile device application using the premises information to determine a need of the subject wearing the wearable device.

An embodiment of a system is described that includes at least one communications module, a wearable device, an application running on a processor of a mobile computing platform, and a plurality of activity devices, wherein the at least one communications module, the wearable device, the application, and the plurality of activity devices are communicatively coupled through wireless communications. The system includes the at least one communications module including at least one environmental sensor, wherein the at least one environmental sensor detects environmental sensor information of a premises.

The system includes placing each communications module at a location in the premises, wherein each communications module periodically transmits a unique number and the detected environmental sensor information, wherein the application detects each unique number of the at least one communications module. The system includes the application organizing linking information, the organizing linking information comprising linking each unique number of the at least one communications module with a distance value and a function, wherein the application transmits the linking information to the wearable device. The system includes the wearable device including one or more sensors that monitor physiological and motion data of a subject wearing the wearable device. The system includes the wearable device detecting a transmission of a communications module of the at least one communications module, the wearable device using information of the detected transmission to extract the detected environmental sensor information, to identify the unique number of the communications module and to estimate a distance from the wearable device to the location of the communications module, the wearable device using the linking information to identify the corresponding function and distance value, the wearable device performing the function when the estimated distance meets at least one criterion with respect to the distance value. The system includes the wearable device using at least one of information of the detected environmental sensor information, information of the performed function, and information of the monitored physiological and motion data to determine a need of the subject wearing the wearable device, wherein the wearable device communicates with at least one activity device of the plurality of activity devices to address the need through an action of the at least one activity device.

A system is described herein that comprises under one embodiment at least one communications module, a wearable device, and an application running on a processor of a computing platform, wherein the at least one communications module, the wearable device and the application are communicatively coupled through wireless communications. The system includes placing each communications module at a location in a premises, wherein each communications module periodically transmits a unique number, wherein the application detects each unique number of one or more communications modules selected from the at least one communications module. The system includes the application organizing linking information, the organizing linking information comprising linking each unique number of the one or more communications modules with a distance value and a function, wherein the application transmits the linking information to the wearable device. The system includes the wearable device detecting a transmission of a communications module of the one or more communications modules, the wearable device using information of the detected transmission to identify the unique number of the communications module and to estimate a distance from the wearable device to the location of the communications module, the wearable device using the linking information to identify the corresponding function and distance value, the wearable device performing the function when the estimated distance meets at least one criterion with respect to the distance value.

The wearable device under an embodiment stores the linking information in a database.

The wearable device using the linking information comprising a database lookup under an embodiment.

The application detecting each unique number includes storing each unique number under an embodiment.

The at least one criterion comprises the estimated distance being less than the distance value under an embodiment.

The at least one criterion comprises the estimated distance being greater than the distance value under an embodiment.

The at least one criterion comprises the estimated distance being between a range of distance values under an embodiment.

The wearable device comprises a collar under an embodiment.

The animal under an embodiment wears the collar.

The computing platform under an embodiment comprises one or more of a smartphone, tablet, desktop computer, laptop computer and mobile computing device.

The performed function comprises under an embodiment logging information of the performed function.

The logged information under an embodiment includes one or more of a time, an occurrence, and a duration of the performed function.

The logging the information under an embodiment comprises associating the time and the occurrence with the unique number of the communications module.

The wearable device transmits the logged information to the application under an embodiment.

The application provides access to the logged information through an electronic interface under an embodiment.

The performed function comprises an avoidance function, wherein the avoidance function comprises applying a negative stimulus to a user of the wearable device under an embodiment.

The performed function comprises a tracking function under an embodiment, wherein the tracking function comprises applying a positive stimulus to a user of the wearable device.

The linking each unique number comprising under an embodiment linking each unique number with a permitted time, the wearable device using the linking information to identify the corresponding permitted time, the wearable device performing the function when a time of the performing comprises the permitted time.

The linking each unique number under an embodiment comprising linking a first unique number with a first distance value, a first function and a first permitted time.

The linking each unique number comprising under an embodiment linking a second unique number with a second distance value, a second function, and a second permitted time.

The first distance value is different than the second distance under an embodiment.

The first function is different than the second function under an embodiment.

The first permitted time is different than the second permitted time under an embodiment.

The application organizing linking information comprises under an embodiment organizing first linking information for a first wearable device, wherein the first linking information includes the linking information and the first wearable device includes the wearable device.

The application organizing linking information comprises under an embodiment organizing second linking information for a second wearable device.

The first linking information is different than the second linking information under an embodiment.

The wireless communications comprises under an embodiment a Bluetooth low energy communications protocol.

The at least one communications module comprises a Bluetooth enabled device under an embodiment.

The wearable device comprises a Bluetooth enabled beacon under an embodiment.

The application provides an electronic interface under an embodiment.

The application detecting each unique number of one or more communications modules selected from the at least one communications module comprises under an embodiment selecting the one or more communications modules using the electronic interface.

The organizing linking information includes under an embodiment using the electronic interface to link each unique number with a distance value and a function.

The one or more of the wearable device, the at least one communications module, and the computing platform are under an embodiment communicatively coupled via Wi-Fi connection to a local router, local area network or local personal area network.

The coupling provides internet connectivity under an embodiment.

The one or more of the wearable device, the at least one communications module, and the computing platform is under an embodiment communicatively coupled with a cloud computing platform comprising one or more applications running on at least one processor of a remote server.

The one or more of the wearable device, the at least one communications module, and the computing platform under an embodiment at least one of transmit data to and receive data from the computing platform.

A system under one embodiment is described herein that includes at least one communications module, a wearable device, and an application running on a processor of a computing platform, wherein the at least one communications module, the wearable device and the application are communicatively coupled through wireless communications, wherein each communications module of the at least one communications module corresponds to a unique number. The system includes placing one or more communications modules of the at least one communications module at a location in a premises, wherein the application transmits to the wearable device identification information, the identification information comprising a corresponding unique number for each communications module of the one or more communications modules, wherein the wearable device stores the identification information. The system includes the application transmitting data to the one or more communications modules, the transmitting the data comprising transmitting a corresponding function and distance value for each communications module of the one or more communications modules. The system includes a communications module of the one or more communications modules periodically transmitting a corresponding unique number, a corresponding function and a corresponding distance value. The system includes the wearable device detecting a transmission of the communications module, the wearable device using information of the detected transmission to identify the unique number of the communications module, the transmitted function, and the transmitted distance value and to estimate a distance from the wearable device to the location of the communications module. The system includes the wearable device locating a presence of the unique number in the stored identification information, wherein upon the locating, the wearable device compares the transmitted distance value with the estimated distance and performs the transmitted function when the estimated distance meets at least one criterion with respect to the transmitted distance value.

The at least one criterion under an embodiment comprises the estimated distance being less than the transmitted distance value.

The at least one criterion under an embodiment comprises the estimated distance being greater than the transmitted distance value.

The at least one criterion under an embodiment comprises the estimated distance being between a range of transmitted distance values.

The performed function under an embodiment comprises logging information of the performed function, wherein the logged information includes a time and an occurrence of the performed function.

The logging the information under an embodiment comprises associating the time and the occurrence with the unique number of the communications module.

The performed function comprises under an embodiment an avoidance function, wherein the avoidance function comprises applying a negative stimulus to a user of the wearable device.

The performed function under an embodiment comprises a tracking function, wherein the tracking function comprises applying a positive stimulus to a user of the wearable device.

A method is described herein that under one embodiment comprises placing a wearable device on a subject that is mobile within a premises. The method includes placing communications modules at one or more locations in the premises, wherein each communications module periodically transmits a unique number, wherein an application running on a processor of a computing platform detects and stores each unique number of one or more communications modules selected from the at least one communications module, wherein the communications modules, the wearable device, and the application are communicatively coupled through wireless communications. The method includes organizing linking information by linking each unique number of the one or more communications modules selected from the at least one communications module with a distance value and a function, wherein the organizing comprises the application organizing the linking information and transmitting the linking information to the wearable device. The method includes the wearable device detecting a transmission of a communications module of the one or more communications modules. The method includes the wearable device using information of the detected transmission to identify the unique number of the communications module and to estimate a distance from the wearable device to a location of the communications module. The method includes the wearable device using the linking information to identify the function and distance value corresponding to the communications module. The method includes the wearable device performing the function when the estimated distance meets at least one criterion with respect to the distance value.

The at least one criterion comprises under an embodiment the estimated distance being less than the distance value.

The at least one criterion comprises under an embodiment the estimated distance being greater than the distance value.

The at least one criterion comprises under an embodiment the estimated distance being between a range of distance values.

A method is described herein that under one embodiment comprises placing a wearable device on a subject that is mobile within a premises. The method includes placing one or more communications modules at a location in the premises. The method includes one or more applications running on at least one processor of a computing platform transmitting identification information to the wearable device, wherein the one or more communications modules, the wearable device and the one or more applications are communicatively coupled through wireless communications, the identification information comprising a corresponding unique number for each communications module of the one or more communications modules, wherein the wearable device stores the identification information. The method includes the one or more applications transmitting data to a communications module of the one or more communications modules, wherein the data comprises a function and a distance value. The method includes the communications module periodically transmitting a unique number, the function and the distance value. The method includes the wearable device detecting a transmission of the communications module, the wearable device using information of the detected transmission to identify the unique number of the communications module, the transmitted function, and the transmitted distance value, and to estimate a distance from the wearable device to the location of the communications module. The method includes the wearable device locating a presence of the unique number in the stored identification information, wherein upon the locating, the wearable device compares the transmitted distance value with the estimated distance and performs the transmitted function when the estimated distance meets at least one criterion with respect to the distance value.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The systems and methods of monitoring a subject in a premises can be a component of a single system, multiple systems, and/or geographically separate systems. The systems and methods of monitoring a subject in a premises can also be a subcomponent or subsystem of a single system, multiple systems, and/or geographically separate systems. The components of the systems and methods of monitoring a subject in a premises can be coupled to one or more other components (not shown) of a host system or a system coupled to the host system.

One or more components of the systems and methods of monitoring a subject in a premises and/or a corresponding interface, system or application to which the systems and methods of monitoring a subject in a premises are coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include the systems and methods of monitoring a subject in a premises can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the systems and methods of monitoring a subject in a premises and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods of monitoring a subject in a premises and corresponding systems and methods include: microcontrollers with memory (such as electronically erasable programmable read only memory (EEPROM)), embedded microprocessors, firmware, software, etc. Furthermore, aspects of the systems and methods of monitoring a subject in a premises and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods of monitoring a subject in a premises and corresponding systems and methods is not intended to be exhaustive or to limit the systems and methods to the precise forms disclosed. While specific embodiments of, and examples for, the systems and methods of monitoring a subject in a premises and corresponding systems and methods are described herein for illustrative purposes, various equivalent modifications are possible within the scope of the systems and methods, as those skilled in the relevant art will recognize. The teachings of the systems and methods of monitoring a subject in a premises and corresponding systems and methods provided herein can be applied to other systems and methods, not only for the systems and methods described above.

The elements and acts of the various embodiments described above can be combined to provide further embodiments. These and other changes can be made to the systems and methods of monitoring a subject in a premises and corresponding systems and methods in light of the above detailed description.

We claim:

1. A system comprising,
at least one communications module, a wearable device, and an application configured to run on a processor of a mobile computing device, wherein the at least one communications module, the wearable device, and the mobile device application are configured to communicatively couple with each other;
at least one application configured to run on one or more processors of a server remote from the at least one communications module, the wearable device, and the mobile device application, wherein the at least one application is configured to communicatively couple with the at least one communications module, the wearable device, and the mobile device application;
wherein:
each communications module is positioned at a location in an environment;
each communications module is configured to periodically transmit a unique number, wherein the mobile device application is configured to detect each unique number of the at least one communications module;
the mobile device application is configured to organize linking information, the organizing linking information comprising linking each unique number of the at least one communications module with a function, wherein the mobile device application is configured to transmit the linking information to the wearable device;
the wearable device is configured to detect a transmission of a communications module of the at least one communications module, to use information of the detected transmission to identify the unique number of the communications module, to use the linking information to identify the function corresponding to the unique number, and to perform the function when at least one criterion is met;
the wearable device is configured to transmit information of the environment to one or more of the at least one application and the mobile device application, wherein the environmental information includes information of the performed function;
one or more of the wearable device, the at least one application and the mobile device application is configured to use the environmental information to determine a need of a subject wearing the wearable device.

2. The system of claim 1, the organizing linking information including linking each unique number of the at least one communications modules with a distance value.

3. The system of claim 2, the using information of the detected transmission comprising estimating a distance from the wearable device to the location of the communications module.

4. The system of claim 3, the using the linking information comprising identifying the corresponding distance value.

5. The system of claim 4, wherein the meeting the at least one criterion comprises the estimated distance being less than the distance value.

6. The system of claim 4, wherein the meeting the at least one criterion comprises the estimated distance being greater than the distance value.

7. The system of claim 4, wherein the meeting the at least one criterion comprises the estimated distance being between a range of distance values.

8. The system of claim 1, wherein the wearable device is configured to store the linking information in a database.

9. The system of claim 8, the using the linking information comprising a database lookup.

10. The system of claim 1, wherein the performed function comprises logging the information of the performed function.

11. The system of claim 10, wherein the logged information includes one or more of a time, an occurrence, and a duration of the performed function.

12. The system of claim 11, wherein the logging the information comprises associating the time and the occurrence with the unique number of the communications module.

13. The system of claim 1, wherein the performed function comprises an avoidance function, wherein the avoidance function comprises applying a negative stimulus to the subject wearing the wearable device.

14. The system of claim 1, wherein the performed function comprises a tracking function, wherein the tracking function comprises applying a positive stimulus to the subject wearing the wearable device.

15. The system of claim 1, the linking each unique number comprising linking each unique number with a permitted time, the using the linking information comprising identifying the corresponding permitted time, wherein the meeting the at least one criterion includes a time of the performed function comprising the permitted time.

16. The system of claim 15, the linking each unique number comprising linking a first unique number with a first function and a first permitted time.

17. The system of claim 16, the linking each unique number comprising linking a second unique number with a second function and a second permitted time.

18. The system of claim 17, wherein the first function is different than the second function.

19. The system of claim 18, wherein the first permitted time is different than the second permitted time.

20. The system of claim 1, wherein the need of the subject wearing the device includes at least one of a need to modify physiological aspects of the subject, a need to modify levels of physical activity, a need to modify occurrences of the performed function, a need to modify environmental conditions, a need to control food consumption, a need to control water consumption, a need to receive medicine, a need to receive nutritional supplements, and a need to receive vitamins.

21. The system of claim 1, wherein the environment includes one or more activity devices, wherein the one or more activity devices are configured to communicatively couple with the at least one communications module, the wearable device, the mobile device application, and the at least one application.

22. The system of claim 21, wherein the one or more of the wearable device, the at least one application and the mobile device application is configured to determine at least one action of the one or more activity devices to address the need.

23. The system of claim 22, wherein the one or more of the wearable device, the at least one application and the mobile device application is configured to communicate with the one or more activity devices to direct performance of the at least one action.

24. The system of claim 22, wherein the one or more activity devices include a device controlling thermostat levels, a device controlling lighting, a device controlling humidity levels, a device controlling operation and function of dispensing devices, a toy device, an audio playback device, a video playback device, a sound control device, and a gatekeeping device.

25. The system of claim 22, wherein the at least one action includes the one or more activity devices controlling access to locations in the environment, adjusting dispensing levels of a food dispensing device, adjusting dispensing levels of a water dispensing device, adjusting temperature levels, adjusting humidity levels, adjusting lighting, adjusting sound levels, activating toy devices, controlling audio playback devices, controlling video playback devices and/or introducing medicines or vitamins through a dispensing device.

26. The system of claim 1, wherein the one or more of the wearable device, the at least one application and the mobile device application is configured to use the environmental information to generate alerts for delivery to an interface of the mobile device application.

27. The system of claim 1, wherein the at least one communications module includes one or more environmental sensors.

28. The system of claim 27, wherein the one or more environmental sensors collect data of the environment.

29. The system of claim 28, wherein the collected environmental data includes timing of occurrence with respect to the collected environmental data.

30. The system of claim 28, wherein the environmental information includes the collected environmental data.

31. The system of claim 28, the periodically transmitting the unique number including periodically transmitting the collected environmental data, the using information of the detected transmission including extracting the collected environmental data.

32. The system of claim 28, wherein the one or more environmental sensors include at least one of a temperature sensor, a moisture sensor, a humidity sensor, an air pressure sensor, and an air quality sensor.

33. The system of claim 1, wherein the wearable device includes one or more physiological sensors.

34. The system of claim 33, wherein the one or more physiological sensors is configured to collect physiological data of the subject wearing the wearable device.

35. The system of claim 34, wherein the collected physiological data includes timing of occurrence with respect to the collected physiological data.

36. The system of claim 34, wherein the one or more physiological sensors include a heart rate sensor, electrocardiogram, a blood pressure sensor, a respiration rate sensor, and temperature sensor.

37. The system of claim 34, wherein the environmental information includes the collected physiological data.

38. The system of claim 1, wherein the wearable device includes at least one activity sensor, wherein the at least one activity sensor is configured to collect motion and orientation data of the subject.

39. The system of claim 38, wherein the environmental information includes the collected motion and orientation data

40. The system of claim 38, wherein the motion and orientation data includes timing of occurrence with respect to collected motion and orientation data.

41. The system of claim 38, wherein the at least one activity sensor includes an accelerometer and/or a gyroscope.

42. The system of claim 1, wherein the environment includes at least one biological sensor located external to the subject wearing the collar device, the at least one external biological sensor collecting biological data of the subject.

43. The system of claim 42, the biological data including timing of occurrence of the collected biological data.

44. The system of claim 42, wherein the at least one external biological sensor includes a heart rate sensor, a respiration sensor, and a temperature sensor.

45. The system of claim 42, wherein the environmental information includes the collected biological data.

46. The system of claim 1, wherein the at least one communications module, the wearable device, and the mobile device application are configured to communicatively couple with each other through a Wi-Fi or WPAN enabled communications network.

47. The system of claim 46, wherein the at least one communications module, the wearable device, and the mobile device application are configured to communicatively couple through a Wi-Fi or WPAN enabled communications network with at least one of a local area network (LAN), metropolitan area network (MAN), wide area network (WAN), the internet, a mobile network, and a cellular network.

48. The system of claim 47, wherein the at least one application is configured to communicatively couple with the at least one of a local area network (LAN), metropolitan area networks (MAN), wide area network (WAN), the internet, a mobile network, and a cellular network

49. A system comprising,
at least one communications module, a wearable device, and an application running on a processor of a mobile computing device, wherein the at least one communications module, the wearable device, and the mobile device application are configured to communicatively couple with each other;
at least one application running on one or more processors of a server remote from the at least one communications module, the wearable device, and the mobile device application, wherein the at least one application is configured to communicatively couple with the at least one communications module, the wearable device, and the mobile device application; wherein
each communications module is positioned at a location in an environment, wherein the mobile device application is configured to transmit identification information to the wearable device, the identification information comprising a corresponding unique number for each communications module of the one or more communications modules, wherein the wearable device is configured to store the identification information;
the mobile device application configured to transmit data to the at least one communications module, the transmitting data including transmitting a corresponding function for each communications module of the at least one communications module;
each communications module of the at least one communications module configured to periodically transmit the corresponding unique number and the corresponding function;
the wearable device configured to detect a transmission of a communications module of the at least one communications module and to use information of the detected transmission to identify the unique number of the communications module and the transmitted function;
the wearable device configured to locate a presence of the unique number in the stored identification information, wherein upon the locating, the wearable device performs the function if at least one criterion is met;
the wearable device configured to transmitting information of the environment to one or more of the at least one application and the mobile device application, wherein the environmental information includes information of the performed function;
one or more of the wearable device, the at least one application and the mobile device application configured to use the environmental information to determine a need of the subject wearing the wearable device.

50. A system comprising,
at least one communications module, a wearable device, an application running on a processor of a mobile computing platform, and a plurality of activity devices, wherein the at least one communications module, the wearable device, the application, and the plurality of activity devices are configured to communicatively couple with each other through wireless communications;
the at least one communications module including at least one environmental sensor, wherein the at least one environmental sensor is configured to detect environmental sensor information of an environment, wherein
each communications module is positioned at a location in the environment, wherein each communications module periodically transmits a unique number and the detected environmental sensor information, wherein the application is configured to detect each unique number of the at least one communications module;
the application configured to organize linking information, the organizing linking information comprising linking each unique number of the at least one communications module with a distance value and a function, wherein the application is configured to transmits the linking information to the wearable device;
the wearable device including one or more sensors that monitor physiological and motion data of a subject wearing the wearable device;
the wearable device configured to detect a transmission of a communications module of the at least one communications module, the wearable device configured to use information of the detected transmission to extract the detected environmental sensor information, the wearable device configured to identify the unique number of the communications module and to estimate a distance from the wearable device to the location of the communications module, the wearable device configured to use the linking information to identify the corresponding function and distance value, the wearable device configured to perform the function when the estimated distance meets at least one criterion with respect to the distance value;
the wearable device configured to use at least one of information of the detected environmental sensor information, information of the performed function, and information of the monitored physiological and motion data to determine a need of the subject wearing the wearable device, wherein the wearable device is configured to communicate with at least one activity device of the plurality of activity devices to address the need through an action of the at least one activity device.
